(19) United States
(12) Patent Application Publication
(10) Pub. No.: US 2026/0118176 A1
(43) Pub. Date: Apr. 30, 2026

(54) INSPECTION METHOD, INSPECTION SYSTEM, AND PROGRAM

(71) Applicant: Yokogawa Test & Measurement Corporation, Tokyo (JP)

(72) Inventor: Manabu Kojima, Tokyo (JP)

(73) Assignee: Yokogawa Test & Measurement Corporation, Tokyo (JP)

(21) Appl. No.: 19/354,919

(22) Filed: Oct. 10, 2025

(30) Foreign Application Priority Data
Oct. 31, 2024 (JP) 2024-192465

(51) Int. Cl. G01J 3/28; G01J 3/02; G01J 3/18

(52) U.S. Cl. CPC G01J 3/28; G01J 3/0218; G01J 3/18

(57) ABSTRACT

A method of inspecting an optical device (80), to be performed by an inspection system (1), includes repeating a process of outputting light from a plurality of optical devices (80) positioned at an inspection position and determining whether the plurality of optical devices (80) includes a defective product based on a spectrum, measured by a spectroscope (15), of superimposed light obtained by superimposing the light from the plurality of optical devices (80), and in a case in which the plurality of optical devices (80) is not determined to include a defective product, moving another plurality of optical devices (80) to the inspection position by a moving unit (40).

### CROSS-REFERENCE TO RELATED APPLICATION

The present application claims priority to Japanese Patent Application No. 2024-192465 filed on October 31, 2024, the entire contents of which are incorporated herein by reference.

### TECHNICAL FIELD

The present disclosure relates to an inspection method, an inspection system, and a program.

### BACKGROUND

There is a known technique for measuring the spectrum of light that is output from an optical device such as a semiconductor laser, and inspecting whether a desired performance is being achieved. For example, Patent Literature (PTL) 1 describes a technique related to an optical spectrum analyzer (OSA).

### CITATION LIST

### Patent Literature

PTL 1: JP 5901916 B2

### SUMMARY

An inspection method according to several embodiments is an inspection method of inspecting an optical device, to be performed by an inspection system, the inspection method comprising:

repeating a process of

outputting light from a plurality of optical devices positioned at an inspection position and determining whether the plurality of optical devices includes a defective product based on a spectrum, measured by a spectroscope, of superimposed light obtained by superimposing the light from the plurality of optical devices; and

in a case in which the plurality of optical devices is not determined to include a defective product, moving another plurality of optical devices to the inspection position by a moving unit.

An inspection system according to several embodiments is an

inspection system comprising:

a moving unit that moves an optical device, and a spectroscope that acquires a spectrum of incident light, wherein

the inspection system repeats a process of

outputting light from a plurality of optical devices positioned at an inspection position and determining whether the plurality of optical devices includes a defective product based on a spectrum, measured by a spectroscope, of superimposed light obtained by superimposing the light from the plurality of optical devices; and

in a case in which the plurality of optical devices is not determined to include a defective product, moving another plurality of optical devices to the inspection position by the moving unit.

A program according to several embodiments is a program for controlling operation of an inspection system including a moving unit that moves an optical device, and a spectroscope that acquires a spectrum of incident light, the program configured to cause the inspection system to repeat a process comprising:

outputting light from a plurality of optical devices positioned at an inspection position and determining whether the plurality of optical devices includes a defective product based on a spectrum, measured by a spectroscope, of superimposed light obtained by superimposing the light from the plurality of optical devices; and

in a case in which the plurality of optical devices is not determined to include a defective product, moving another plurality of optical devices to the inspection position by the moving unit.

### BRIEF DESCRIPTION OF THE DRAWINGS

In the accompanying drawings:

FIG. 1 is a diagram illustrating a configuration of an inspection system according to a comparative example;

FIG. 2 is a diagram illustrating a configuration example of an inspection system according to an embodiment of the present disclosure;

FIG. 3 is a diagram illustrating the optical spectrum of one optical device;

FIG. 4 is a diagram illustrating an optical spectrum in which light from a plurality of optical devices is mixed;

FIG. 5 is a diagram illustrating an optical spectrum of an optical device that is a defective product;

FIG. 6 is a diagram illustrating an optical spectrum in which light from a plurality of optical devices including a defective product is mixed;

FIG. 7 is a block diagram illustrating an example of a functional configuration of the OSA in FIG. 2;

FIG. 8A is a flowchart illustrating an example of the operation of the inspection system in FIG. 2;

FIG. 8B is a flowchart illustrating an example of the individual inspection process in FIG. 8A;

FIG. 9 is a diagram illustrating a configuration example of the spectroscope in FIG. 7;

FIG. 10A is a diagram illustrating an example end face of a beam combiner configured as an optical fiber bundle; and

FIG. 10B is a diagram illustrating an example end face of a beam combiner configured as an optical fiber bundle.

### DETAILED DESCRIPTION

At optical device manufacturing sites, it is important to efficiently inspect a large number of optical devices. Specifically, when inspecting all manufactured optical devices, a strong desire exists for shortening the inspection takt time, which is the inspection time per device.

The conventional configuration has room for improvement in terms of shortening the inspection takt time.

It would be helpful to shorten the inspection takt time for optical devices.

An inspection method according to several embodiments is (1) an inspection method of inspecting an optical device, to be performed by an inspection system, the inspection method comprising:

repeating a process of

outputting light from a plurality of optical devices positioned at an inspection position and determining whether the plurality of optical devices includes a defective product based on a spectrum, measured by a spectroscope, of superimposed light obtained by superimposing the light from the plurality of optical devices; and

in a case in which the plurality of optical devices is not

determined to include a defective product, moving another plurality of optical devices to the inspection position by a moving unit.

In this way, the inspection method does not inspect optical devices one by one,but rather inspects a plurality of optical devices at once, making it possible to shorten the inspection takt time for the optical devices.

An embodiment may be (2) the inspection method of (1), wherein in a case in which the plurality of optical devices is determined to include a defective product, light is outputted from each individual optical device among the plurality of optical devices, and it is determined whether each individual optical device is a defective product based on a spectrum of the light measured by the spectroscope.

In this way, in a case in which it is determined that the plurality of optical devices includes a defective product, the inspection method inspects each optical device included in the plurality of optical devices and can thereby efficiently identify a defective product when such a defective product exists.

An embodiment may be (3) the inspection method of (1) or (2), wherein the determining of whether the plurality of optical devices includes a defective product is based on a comparison between a side mode suppression ratio of the spectrum of the superimposed light and a predetermined threshold.

In this way, the inspection method determines whether the optical device is defective or non-defective based on the side mode suppression ratio as an evaluation index and can thereby perform effective inspection.

An embodiment may be (4) the inspection method of any one of (1) to (3), wherein the spectrum of the superimposed light is measured by inputting the superimposed light to the spectroscope using a beam combiner that combines a plurality of optical fibers that transmit the light outputted from the plurality of optical devices.

In this way, the inspection method uses the beam combiner to input the superimposed light to the spectroscope, thereby achieving a simple configuration for determining whether the optical devices are defective or non-defective based on the superimposed light.

An embodiment may be (5) the inspection method of (4), wherein the superimposed light is inputted to the spectroscope by a bundle optical fiber that bundles the plurality of optical fibers as the beam combiner.

In this way, the inspection method uses the optical fiber bundle as the beam combiner and can thereby minimize the loss of light.

An inspection system according to several embodiments is (6) an inspection system comprising:

a moving unit that moves an optical device, and a spectroscope that acquires a spectrum of incident light, wherein

the inspection system repeats a process of

outputting light from a plurality of optical devices positioned at an inspection position and determining whether the plurality of optical devices includes a defective product based on a spectrum, measured by the spectroscope, of superimposed light obtained by superimposing the light from the plurality of optical devices; and

in a case in which the plurality of optical devices is not determined to include a defective product, moving another plurality of optical devices to the inspection position by the moving unit.

In this way, the inspection system does not inspect optical devices one by one,but rather inspects a plurality of optical devices at once, making it possible to shorten the inspection takt time for the optical devices.

An embodiment may be (7) the inspection system of (6), wherein in a case in which the plurality of optical devices is determined to include a defective product, light is outputted from each individual optical device among the plurality of optical devices, and it is determined whether each individual optical device is a defective product based on a spectrum of the light measured by the spectroscope.

In this way, in a case in which it is determined that the plurality of optical devices includes a defective product, the inspection system inspects each optical device included in the plurality of optical devices and can thereby efficiently identify a defective product when such a defective product exists.

An embodiment may be (8) the inspection system of (6) or (7), wherein the determining of whether the plurality of optical devices includes a defective product is based on a comparison between a side mode suppression ratio of the spectrum of the superimposed light and a predetermined threshold.

In this way, the inspection system determines whether the optical device is defective or non-defective based on the side mode suppression ratio as an evaluation index and can thereby perform effective inspection.

An embodiment may be (9) the inspection system of any one of (6) to (8), further comprising

a beam combiner that combines a plurality of optical fibers that

transmit the light outputted from the plurality of optical devices, wherein

the spectroscope measures the spectrum of the superimposed light inputted from the beam combiner.

In this way, the inspection system uses the beam combiner to input the superimposed light to the spectroscope, thereby achieving a simple configuration for determining whether the optical devices are defective or non-defective based on the superimposed light.

An embodiment may be (10) the inspection system of (9), comprising, as the beam combiner, a bundle optical fiber that bundles the plurality of optical fibers.

In this way, the inspection system uses the optical fiber bundle as the beam combiner and can thereby minimize the loss of light.

An embodiment may be (11) the inspection system of (10), wherein

the spectroscope is a monochromator including a diffraction grating, rotatable about a rotation axis, that diffracts incident light at a predetermined angle according to a wavelength of the incident light, and a photodiode that detects an intensity of the superimposed light diffracted by the diffraction grating, the monochromator measuring the spectrum of the superimposed light based on a rotation angle of the diffraction grating and the intensity of the superimposed light detected by the photodiode, and

the beam combiner bundles the plurality of optical fibers in a line perpendicular to a rotation plane of the diffraction grating.

In this way, by bundling the optical fibers in a line perpendicular to the rotation plane of the diffraction grating, the inspection system can reduce the relative wavelength error of the measured light between the optical fibers and accurately determine whether the optical devices are defective or non-defective.

A program according to several embodiments is (12) a program for controlling operation of an inspection system including a moving unit that moves an optical device, and a spectroscope that acquires a spectrum of incident light, the program configured to cause the inspection system to repeat a process comprising:

outputting light from a plurality of optical devices positioned at an inspection position and determining whether the plurality of optical devices includes a defective product based on a spectrum, measured by the spectroscope, of superimposed light obtained by superimposing the light from the plurality of optical devices; and

in a case in which the plurality of optical devices is not determined to include a defective product, moving another plurality of optical devices to the inspection position by the moving unit.

In this way, the program does not inspect optical devices one by one, but rather inspects a plurality of optical devices at once, making it possible to shorten the inspection takt time for the optical devices.

According to an embodiment of the present disclosure, the inspection takt time for optical devices can be reduced.

### Comparative Example

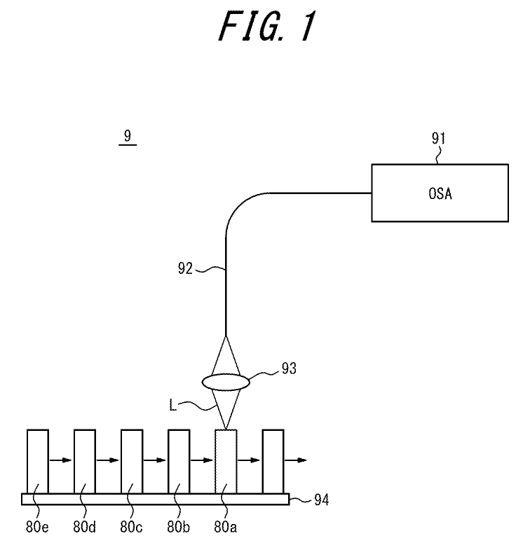

FIG. 1 is a diagram illustrating a configuration of an inspection system 9 according to a comparative example. The inspection system 9 measures the optical spectrum of optical devices 80 (80a, 80b, 80c, 80d, 80e), such as semiconductor lasers, to inspect the characteristics of the optical devices 80. As illustrated in FIG. 1, the inspection system 9 includes an OSA 91, an optical fiber 92, a condenser lens 93, and a moving stage 94.

The inspection system 9 causes the optical device 80a that is the inspection target to emit light using a constant current power supply or the like. The light L outputted from the optical device 80a is inputted to an optical fiber 92 by a condenser lens 93. The optical fiber 92 transmits the light L inputted from the optical device 80a to the OSA 91. The OSA 91 measures the spectrum of the inputted light L by a spectroscope to inspect the characteristics of the optical device 80a. The OSA 91 inspects the spectrum of the light L from the optical device 80a that is the inspection target using an evaluation index, called a side mode suppression ratio, or the like and determines whether the device is a defective product or a non-defective product.

The inspection system 9 according to the comparative example moves the optical devices 80 by a moving stage 94 and inspects the optical devices 80a, 80b, 80c, 80d, and 80e one by one. That is, the inspection system 9 repeats a series of operations: (1) outputting light L from the optical device 80 that is the inspection target, (2) spectrally analyzing the light L to make a defective/non-defective determination, and (3) moving the optical device 80 to the next inspection target using the moving stage 94.

When carrying out such 100% inspection of the optical devices 80, it is highly desirable to shorten the inspection takt time.

For example, suppose that (1) the time required for the optical device 80 to output light L (light emission time) is 0.1 s (seconds), (2) the time required for performing spectrum analysis of the light L and making the defective/non-defective determination (measurement time by the OSA) is 1 s, and (3) the time required to move the optical devices 80 to the next inspection target using the moving stage 94 (stage movement time) is 2 s. In this case, the time required to inspect one optical device 80 is 3.1 s (i.e., 0.1 s + 1 s + 2 s). The measurement time by the OSA (1 s) and the stage movement time (2 s) are the dominant contributors to the inspection time (3.1 s) for one optical device 80.

For example, the time required to inspect all of the five optical devices 80a, 80b, 80c, 80d, and 80e is 15.5 s (i.e., 3.1 s × 5). In an actual manufacturing process, inspections are performed on a scale of several thousand or tens of thousands of products. Therefore, in the comparative example, the measurement time by the OSA and the stage movement time are required for each optical device 80, thus leaving room for improvement in shortening the inspection takt time.

### Embodiment

An embodiment of the present disclosure will be described below, with reference to the drawings. In each drawing, parts having the same configuration or function are labeled with the same reference numerals. In the description of the present embodiment, repetitive descriptions of the same parts may be omitted or simplified as appropriate.

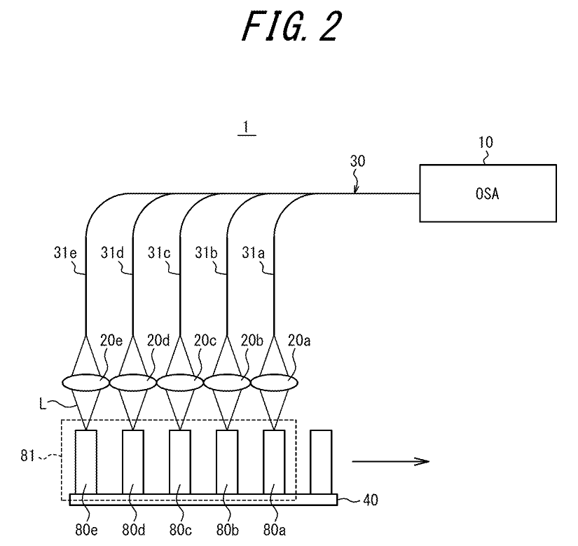

FIG. 2 is a diagram illustrating a configuration example of an inspection system 1 according to an embodiment of the present disclosure. The inspection system 1 measures the optical spectrum of the optical devices 80 (80a, 80b, 80c, 80d, and 80e) to inspect the characteristics of the optical devices 80. As illustrated in FIG. 2, the inspection system 1 includes an OSA 10, a plurality of condenser lenses 20 (20a, 20b, 20c, 20d, and 20e), a beam combiner 30, and a moving stage 40.

The optical devices 80 (80a, 80b, 80c, 80d, and 80e) are targets for inspection of their optical spectrum. The optical device 80 is any device for which a spectral test is performed on the light outputted from the optical device 80. For example, the optical device 80 is a semiconductor laser such as an LED (Laser Emitting Diode), but is not limited to this and may be, for example, an optical bandpass filter. The following description will focus on an example in which the optical device 80 is a semiconductor laser that emits light using a constant current power supply.

The moving stage 40 as a moving unit conveys the plurality of optical devices 80. The moving stage 40 is, for example, a belt conveyor, but may be realized by any device capable of moving the optical devices 80.

The plurality of condenser lenses 20 (20a, 20b, 20c, 20d, 20e) input the light L, outputted from the plurality of optical devices 80 (80a, 80b, 80c, 80d, 80e) that are the inspection targets, into optical fibers 31 (31a, 31b, 31c, 31d, 31e). In the example in FIG. 2, each condenser lens 20 is configured by one optical element, but the condenser lens 20 may be configured by a plurality of optical elements. In the example in FIG. 2, the inspection system 1 includes five condenser lenses 20, but the number of condenser lenses 20 may be selected freely.

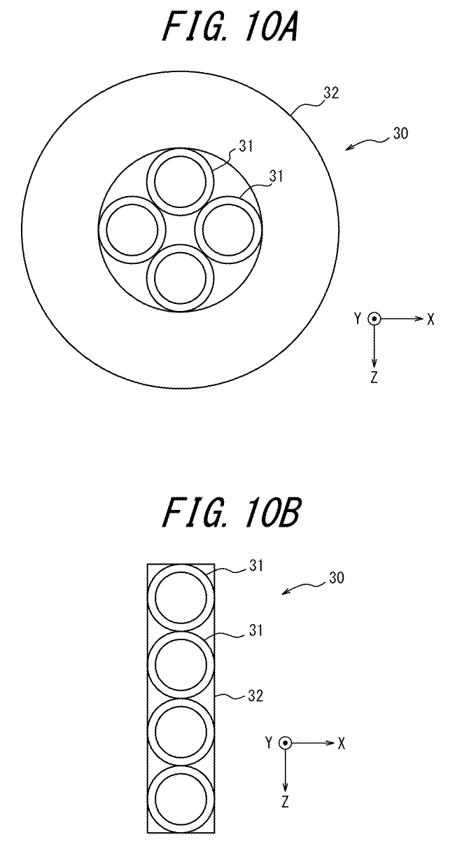

The beam combiner 30 simultaneously inputs the light L outputted from the plurality of optical devices 80 to the OSA 10. The beam combiner 30 includes a plurality of optical fibers 31 and combines the plurality of optical fibers 31. The beam combiner 30 may be realized by any device capable of combining a plurality of optical fibers 31. For example, the beam combiner 30 is an optical fiber bundle (see FIGS. 10A and 10B) that bundles a plurality of optical fibers 31, but is not limited to this. For example, the beam combiner 30 may be configured by combining a plurality of optical couplers in a nested manner. If the beam combiner 30 is configured by combining a plurality of optical couplers in a nested manner, optical loss may occur due to coupling. If the beam combiner 30 is configured as an optical fiber bundle, such light loss can be reduced.

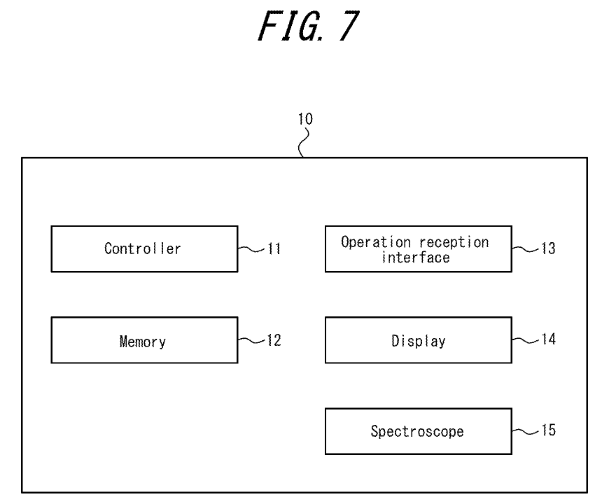

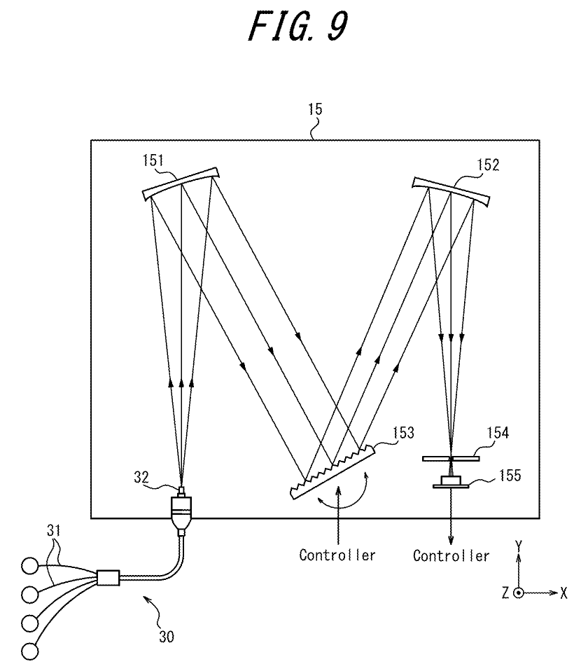

The OSA 10 measures the spectrum of the light from the plurality of optical devices 80 inputted from the beam combiner 30 and performs a defective/non-defective determination. An example configuration of the OSA 10 will be described later with reference to FIG. 7, FIG. 9, and the like.

Next, operations of the inspection system 1 for inspecting the optical device 80 will be described. The inspection system 1 treats a plurality of optical devices 80 as one unit (hereinafter also referred to as an "inspection unit 81") and performs inspection for each inspection unit 81, thereby making it possible to shorten the inspection takt time.

Specifically, the inspection system 1 uses a plurality of constant current power supplies or the like to simultaneously cause a plurality of optical devices 80 located at the inspection position to emit light. Here, an example will be described in which five optical devices 80a, 80b, 80c, 80d, and 80e are inspected as one inspection unit 81.

The light L (laser light) outputted from the five optical devices 80 (80a, 80b, 80c, 80d, 80e) is inputted to optical fibers 31 (31a, 31b, 31c, 31d, 31e) by the plurality of condenser lenses 20 (20a, 20b, 20c, 20d, 20e). The light from each optical fiber 31 (31a, 31b, 31c, 31d, 31e) is simultaneously inputted to the OSA 10 by the beam combiner 30. The OSA 10 measures the spectrum of the inputted light and performs a defective/non-defective determination.

The OSA 10 may make the defective/non-defective determination using an evaluation index called a Side Mode Suppression Ratio (SMSR), for example.

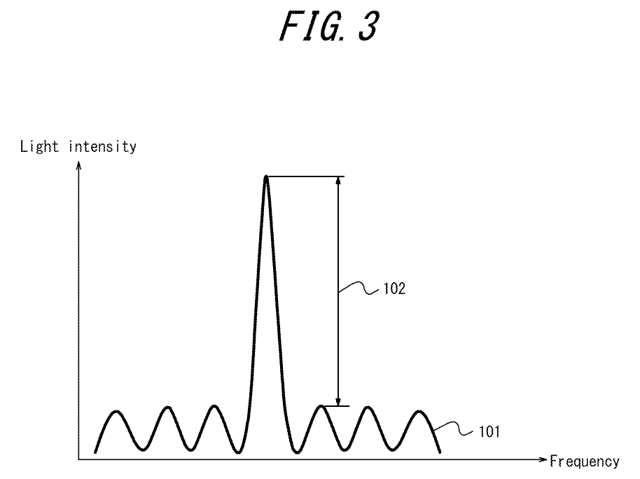

FIG. 3 is a diagram illustrating the optical spectrum of one optical device 80. In FIG. 3, the horizontal axis represents frequency. The vertical axis represents the light intensity. The graph 101 illustrates the optical spectrum of the optical device 80. The side mode suppression ratio is the intensity ratio between the peak with the highest spectral intensity (main mode) and the second highest peak (side mode). When the optical intensity is expressed in dB (decibels), the inter-peak difference 102 in FIG. 3 represents the side mode suppression ratio.

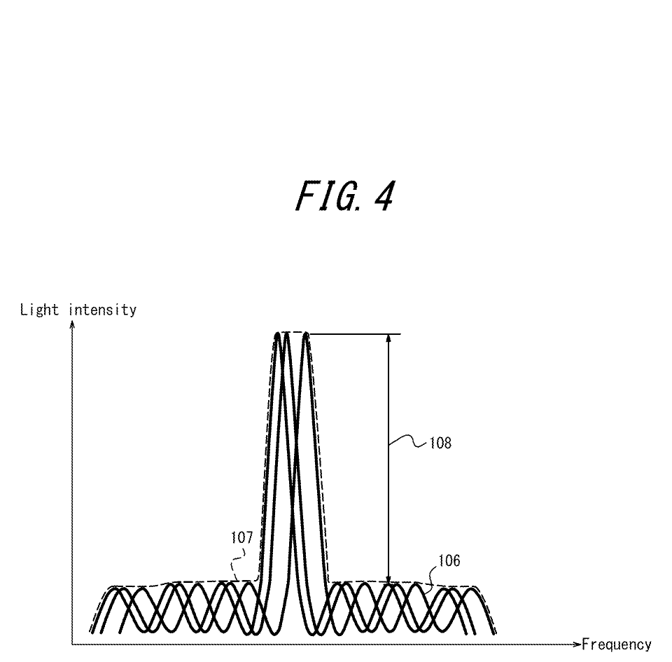

FIG. 4 is a diagram illustrating an optical spectrum in which light from the plurality of optical devices 80 is mixed. In FIG. 4, the horizontal axis represents frequency. The vertical axis represents the light intensity. The graphs 106 illustrate the optical spectrum of each of the optical devices 80 (80a, 80b, 80c, 80d, and 80e). The graph 107 is the envelope of each graph 106. When the light L from a plurality of optical fibers 31 is inputted simultaneously as in FIG. 2, the OSA 10 measures a spectrum such as that illustrated by the graph 107 in FIG. 4.

In one line, each optical device 80 is the same type of device with the same specifications. The spectrum of the light L output from each optical device 80 is generally similar. Therefore, when all the optical devices 80 in the same inspection unit 81 are non-defective products, the shape of the graph 107 is generally similar to that of the graph 106, as illustrated in FIG. 4.

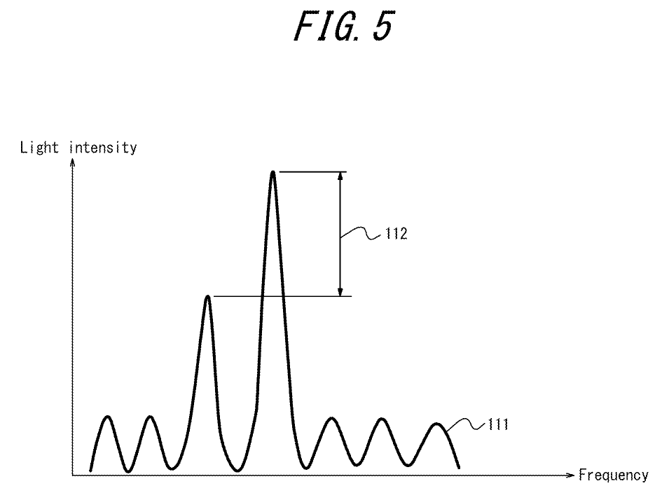

FIG. 5 is a diagram illustrating an optical spectrum of an optical device 80 that is a defective product. In FIG. 4, the horizontal axis represents frequency. The vertical axis represents the light intensity. The graph 106 illustrates the optical spectrum of the defective optical device 80. As illustrated in FIG. 5, for the defective product, the side mode suppression ratio indicated by the inter-peak difference 112 is smaller than the difference 102 (FIG. 3) of a non-defective product. Therefore, when the side mode suppression ratio of the light L outputted from the optical device 80 is smaller than a threshold, the optical device 80 is determined to be defective.

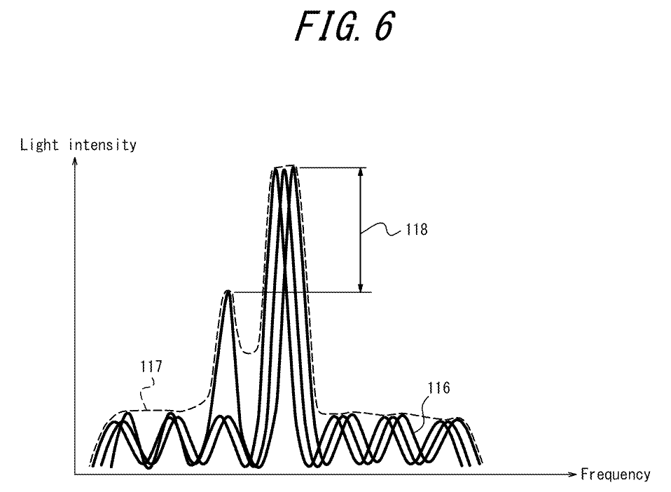

FIG. 6 is a diagram illustrating an optical spectrum in which light from a plurality of optical devices 80 including a defective product is mixed. In FIG. 6, the horizontal axis represents frequency. The vertical axis represents the light intensity. The graph 116 illustrates the optical spectrum of each of the optical devices 80 (80a, 80b, 80c, 80d, and 80e). The graph 117 is the envelope of each graph 116. As illustrated in FIG. 6, in a case in which at least one optical device 80 among the optical devices 80 in the same inspection unit 81 is a defective product, the side mode suppression ratio indicated by the inter-peak difference 118 is smaller than the difference 108 (FIG. 4) when all the optical devices 80 are non-defective products. Therefore, by determining whether the side mode suppression ratio of the optical spectrum measured for the entire inspection unit 81 is smaller than a threshold, it is possible to inspect whether a defective product is included in the optical devices 80 included in the inspection unit 81.

The inspection system 1 therefore simultaneously inspects the optical spectra of a plurality of optical devices 80 positioned at the inspection position as an inspection unit 81. Here, in a case in the optical devices 80 in the same inspection unit 81 are determined to be a non-defective product, the inspection system 1 drives the moving stage 40 so that each optical device 80 in the next inspection unit 81 moves to the inspection position to become the inspection target. In a case in which the optical devices 80 in the inspection unit 81 are determined to include a defective product, the inspection system 1 uses a constant current power supply or the like for each optical device 80 to cause each optical device 80 to emit light one by one,and performs a defective/non-defective determination for each optical device 80.

During the inspection of each inspection unit 81, movement by the moving stage 40 is not necessary, and in the case of a determination of "non-defective", the inspection of a plurality of optical devices 80 can be completed by a single OSA measurement. Furthermore, even if the inspection of an inspection unit 81 results in a determination of "defective", the defective/non-defective determination of each optical device 80 in the corresponding inspection unit 81 does not require movement by the moving stage 40.

Therefore, according to the present embodiment, it is possible to reduce the inspection takt time.

For example, as in the comparative example, suppose that the light emission time of the optical device 80 is 0.1 s, the measurement time by the OSA 10 is 1 s, and the stage movement time of the moving stage 40 is 2 s. In this case, in the inspection system 1, the inspection time for the inspection unit 81 consisting of five optical devices 80 that are all non-defective products is 3.1 s (i.e., 0.1 s (light emission time) + 1 s (measurement time by OSA) + 2 s (stage movement time)). The inspection time for an inspection unit 81 including a defective product is 8.6 s (i.e., 3.1 s (inspection time for the inspection unit 81) + (0.1 s (light emission time) + 1 s (measurement time by OSA)) × 5). Therefore, in either case, the time is shorter than 15.5 seconds, which is the time required for the inspection system 9 according to the comparative example to inspect five optical devices 80. Therefore, according to the inspection system 1 of the present embodiment, it is possible to shorten the inspection takt time for the optical devices 80.

In this way, the inspection system 1 performs inspection for one inspection unit 81, which consists of a plurality of optical devices 80, at a time and can therefore shorten the inspection takt time. In particular, in a case in which the majority of the optical devices 80 that are inspection targets are non-defective products, with only a small portion (e.g., a few percent or less) of the optical devices 80 being defective products, the inspection takt time can be shortened more effectively.

FIG. 7 is a block diagram illustrating an example of a functional configuration of the OSA 10 in FIG. 2. The OSA 10 includes a controller 11, a memory 12, an operation reception interface 13, a display 14, and a spectroscope 15.

The controller 11 includes one or more processors. In an embodiment, the “processor” can be a general-purpose processor or a dedicated processor specialized for particular processing, but the processor is not limited to these examples. The controller 11 is communicably connected to each component of the OSA 10 and controls the operation of the entire OSA 10.

The memory 12 stores any information used in the operation of the OSA 10. The memory 12 includes any storage module, such as a solid state drive (SSD), a read-only memory (ROM), and a random access memory (RAM).

The operation reception interface 13 includes one or more input

interfaces that receive an input operation from a user and acquire input information based on the user operation. For example, the operation reception interface 13 may be a physical key, a capacitance key, a touch screen that is integrated with the display of the display 14, or the like, but is not limited to these.

The display 14 includes one or more output interfaces that output information to the user to notify the user. The display 14 may be, for example, a liquid crystal panel display or an organic EL (Electro Luminescence) display. Either or both of the operation reception interface 13 and the display 14 may be configured integrally with the OSA 10, or they may be provided separately.

The spectroscope 15 separates the light L from the optical device 80 by frequency to acquire the spectrum of the light. The spectroscope 15 is configured, for example, by a monochromator (FIG. 9), described below, but may be realized by any device having a function as a spectroscope (for example, a polychromator).

The functions of the OSA 10 can be realized by executing a computer program (program) according to the present embodiment on a processor included in the controller 11. That is, the functions of the OSA 10 can be realized by software. The computer program causes a computer to execute the processing steps included in the operation of the OSA 10, thereby causing the computer to realize the functions corresponding to the processing of each step. That is, the computer program is a program for causing a computer to function as the OSA 10 according to the present embodiment.

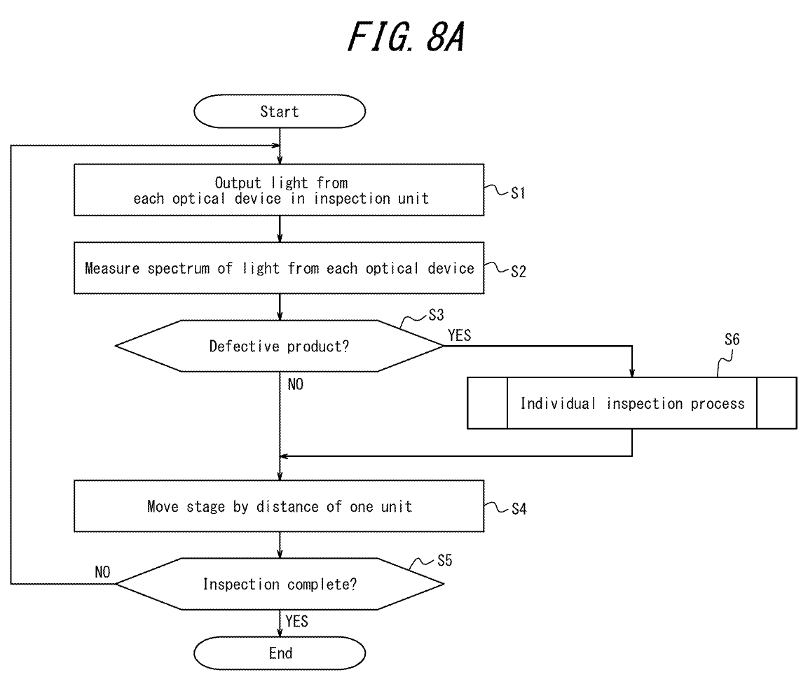

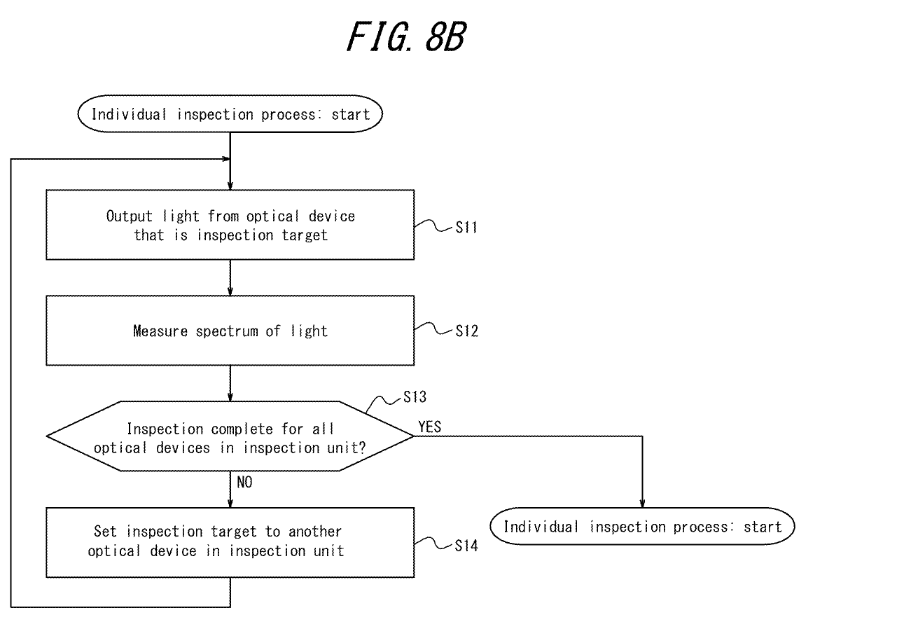

An example of the operation of the inspection system 1 will be described with reference to FIGS. 8A and 8B. FIG. 8A is a flowchart illustrating an example of the operation of the inspection system 1 in FIG. 2. FIG. 8B is a flowchart illustrating an example of the individual inspection process in FIG. 8A. The operation of the inspection system 1 described with reference to FIGS. 8A and 8B may correspond to one of the inspection methods of the inspection system 1. The operations of each step in FIG. 8A and FIG. 8B may be executed based on control by the controller 11 of the OSA 10.

In the present embodiment, an example of operation in which the OSA 10 controls not only the operation of the OSA 10 itself but also the operations of the moving stage 40 and the constant current power supply will be described, but this configuration is not limiting. For example, a control device that controls the operations of the OSA 10, the moving stage 40, and the constant current power supply may be provided separately, and the control device may control the overall operation of the inspection system 1. Such a control device may be a general-purpose device, such as a PC (Personal Computer), that is equipped with a processor.

In step S1 of FIG. 8A, the controller 11 outputs light L from each optical device 80 in the inspection unit 81. Specifically, each optical device 80 in the inspection unit 81 is driven by a constant current power supply to output light L. In addition, when the optical device 80 that is the inspection target is an optical bandpass filter or the like, the controller 11 may input light to each of the optical devices 80 from the distal side, as viewed from the OSA 10, to output light L from each optical device 80.

In step S2, the controller 11 measures the spectrum of the light L from each optical device 80 in the inspection unit 81. Specifically, when each optical device 80 outputs light L in step S1, each instance of the light L is superimposed to yield superimposed light, which is inputted to the spectroscope 15 of the OSA 10. The controller 11 therefore measures the spectrum of this superimposed light using the spectroscope 15.

In step S3, the controller 11 determines whether the inspection unit 81 includes a defective optical device 80, based on the spectrum of the superimposed light measured in step S2. Specifically, the controller 11 may analyze the spectrum of the superimposed light to acquire the side mode suppression ratio, and in a case in which the side mode suppression ratio is smaller than a predetermined threshold, determine that the inspection unit 81 includes a defective optical device 80. The controller 11 may store the inspection results in the memory 12 or display them on the display 14. In a case in which the controller 11 determines that a defective optical device 80 is included (YES in step S3), the process proceeds to step S6. Otherwise (NO in step S3), the controller 11 proceeds to step S4.

In step S4, the controller 11 drives the moving stage 40 the distance of one unit to move each optical device 80 of the next inspection unit 81 to the inspection position corresponding to the condenser lenses 20.

In step S5, the controller 11 determines whether to end the inspection. For example, the controller 11 may determine that the inspection is to be ended in a case in which the inspection of all optical devices 80 that are inspection targets is completed. In a case of determining that the inspection is to be ended (YES in step S5), the controller 11 ends the process of the flowchart in FIG. 8A. Otherwise (NO in step S5), the controller 11 returns to step S1.

In step S6, the controller 11 executes an individual inspection process. The individual inspection process is a process for inspecting each optical device 80 included in the inspection unit 81. The individual inspection process will be described in detail below with reference to FIG. 8B. When the individual inspection process is completed, the controller 11 proceeds to step S4.

The individual inspection process in step S6 will be described with reference to FIG. 8B. In step S11 of FIG. 8B, the controller 11 outputs light from an optical device 80 that is an inspection target included in the inspection unit 81. The optical device 80 that is the inspection target is any one of the optical devices 80 included in the inspection unit 81 (for example, the optical device 80a). For example, in a case in which the optical device 80 is a semiconductor laser, the controller 11 may supply power from a constant current power supply to the optical device 80 that is the inspection target to cause the optical device 80 to emit light.

In step S12, the controller 11 uses the spectroscope 15 to measure the optical spectrum from the optical device 80 (for example, the optical device 80a) that is the inspection target. The controller 11 analyzes the optical spectrum and makes a defective/non-defective determination for the optical device 80. For example, the controller 11 may make the defective/non-defective determination based on whether the side mode suppression ratio of the optical spectrum is smaller than a predetermined threshold. The controller 11 may store the inspection results in the memory 12 or display them on the display 14.

In step S13, the controller 11 determines whether the inspection of all the optical devices 80 included in the inspection unit 81 has been completed. In a case in which the inspection is completed (YES in step S13), the controller 11 ends the individual inspection process and proceeds to step S4 in FIG. 8A. In a case in which the inspection is not completed (NO in step S13), the controller 11 proceeds to step S14.

In step S14, the controller 11 sets another optical device 80 (for example, the optical device 80b) included in the inspection unit 81 as the optical device 80 that is the inspection target. The controller 11 then returns to step S11.

In this way, the inspection system 1 causes the plurality of optical devices 80 included in the inspection unit 81 to emit light simultaneously and inputs the light into the spectroscope 15 of the OSA 10 via the beam combiner 30 to perform the inspection. The inspection system 1 thus performs the inspection for one inspection unit 81 at a time, thereby making it possible to reduce the inspection time.

The beam combiner 30 may be provided coupled to the OSA 10, as in the optical band filter of the optical spectrum device in PTL 1. Such an example configuration will be described with reference to FIGS. 9, 10A, and 10B. Here, the beam combiner 30 is configured as an optical fiber bundle that bundles together a plurality of optical fibers 31.

FIG. 9 is a diagram illustrating a configuration example of the spectroscope 15 in FIG. 7. FIG. 9 illustrates an example of the spectroscope 15 configured as a monochromator. The spectroscope 15 includes a collimating mirror 151, a focusing mirror 152, a diffraction grating 153, an exit slit 154, and a photodiode 155.

The collimating mirror 151 and the focusing mirror 152 are parabolic mirrors.

The diffraction grating 153 is configured by extremely fine grooves cut into a mirror. The diffraction grating 153 is an optical element that extracts light of a specific wavelength from light containing a mixture of various wavelengths. When light of various wavelengths is incident on the diffraction grating 153, diffraction occurs at a predetermined angle according to each wavelength. Therefore, the wavelength can be identified based on the diffraction angle from the diffraction grating 153.

The exit slit 114 adjusts the wavelength resolution, light amount, and the like of the spectroscope 15. The photodiode 155 photoelectrically converts the incident light and outputs an electrical signal according to the intensity of the incident light.

In the spectroscope 15, the beam combiner 30 is an optical fiber bundle, and light incident from the bundle-side end face 32 of the beam combiner 30 is collimated by the collimating mirror 151 and is guided to the diffraction grating 153. The light diffracted by the diffraction grating 153 is focused by the focusing mirror 152 into a spectrum in the dispersion direction with the exit slit 114 as the center. Therefore, only light of the wavelength, within the spectrum, that is focused on the exit slit 114 is detected by the photodiode 155. The wavelength of the light to be detected, i.e., the central wavelength of the optical bandpass filter, can be changed by rotating the diffraction grating 153. Therefore, the spectroscope 15 can measure the spectrum of the incident light by obtaining the relationship between the angle of the diffraction grating 153 corresponding to the wavelength of the incident light and the intensity of the light detected by the photodiode 155.

FIGS. 10A and 10B are diagrams illustrating an example of the end face 32 of the beam combiner 30 configured as an optical fiber bundle. FIGS. 10A and 10B illustrate an example in which four optical fibers 31 are bundled, but any number of optical fibers 31 may be bundled. The end face 32 of the beam combiner 30 on the bundle side may have a shape such that the optical fibers 31 are bundled in a ring at high density, as illustrated in FIG. 10A. Alternatively, as illustrated in FIG. 10B, the optical fibers 31 may be bundled in a line. As illustrated in FIG. 10B, by bundling the optical fibers 31 in a line perpendicular to the rotation plane of the diffraction grating 153, the spectrum of the light to be measured inputted from each optical fiber 31 can be measured with little relative wavelength error.

As described above, the inspection system 1 includes the moving stage 40 that moves the optical devices 80 and the spectroscope 15 that obtains the spectrum of the incident light. The inspection system 1 outputs light from the plurality of optical devices 80 positioned at the inspection position and determines whether the plurality of optical devices 80 includes a defective product based on the spectrum, measured by the spectroscope 15, of superimposed light obtained by superimposing the light from the plurality of optical devices 80. In a case in which the plurality of optical devices 80 is not determined to include a defective product, the inspection system 1 moves another plurality of optical devices 80 to the inspection position by the moving stage 40. The inspection system 1 repeats such inspection and movement one inspection unit 81 at a time.

In this way, the inspection system 1 does not inspect the optical devices 80 one by one,but rather inspects a plurality of optical devices 80 (inspection unit 81) at once, making it possible to shorten the inspection takt time for the optical devices 80.

Furthermore, in a case in which it is determined that the optical devices 80 include a defective product, the inspection system 1 determines whether each individual optical device 80 among the plurality of optical devices 80 is defective. The inspection system 1 can therefore efficiently identify a defective product when such a defective product exists.

The inspection system 1 also determines whether the optical devices 80 include a defective product based on a comparison between the side mode suppression ratio of the spectrum of the superimposed light and a predetermined threshold. The inspection system 1 can therefore perform effective inspection.

The inspection system 1 also includes the beam combiner 30 that combines the plurality of optical fibers 31 that transmit the light outputted from the plurality of optical devices 80. The spectroscope 15 measures the spectrum of the superimposed light inputted from the beam combiner 30. In this way, the inspection system 1 uses the beam combiner 30 to input the superimposed light to the spectroscope 15, thereby achieving a simple configuration for determining whether the optical devices 80 are defective or non-defective based on the superimposed light.

Furthermore, the inspection system 1 may include, as the beam combiner 30, an optical fiber bundle that bundles the plurality of optical fibers 31 together. With this configuration, the loss of light can be minimized compared to a case in which the beam combiner 30 is realized by combining a plurality of couplers.

The inspection system 1 may also include a monochromator as the spectroscope 15. The monochromator may include the diffraction grating 153 and the photodiode 155. The diffraction grating 153 is an optical element that diffracts incident light at a predetermined angle according to the wavelength of the light, and is rotatable about a rotation axis (the Y axis in the example in FIG. 9). The photodiode 155 detects the intensity of the superimposed light diffracted by the diffraction grating 153. The monochromator measures the spectrum of the superimposed light based on the rotation angle of the diffraction grating 153 and the intensity of the superimposed light detected by the photodiode 155. In this case, the beam combiner 30 may bundle the plurality of optical fibers 31 in a line perpendicular (in the Z-axis direction in the example in FIG. 10B) to the rotation plane of the diffraction grating 153 (the XY plane in the example in FIG. 9), as illustrated in FIG. 10B. In this way, by bundling the optical fibers 31 in a line perpendicular to the rotation plane of the diffraction grating 153, the inspection system 1 can reduce the relative wavelength error of the measured light between the optical fibers 31 and accurately determine whether the optical devices 80 are defective or non- defective.

The present disclosure is not limited to the embodiments described above. For example, a plurality of blocks described in the block diagrams may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

1. An inspection method of inspecting an optical device, to be performed by an inspection system, the inspection method comprising:
repeating a process of
outputting light from a plurality of optical devices positioned at an inspection position and determining whether the plurality of optical devices includes a defective product based on a spectrum, measured by a spectroscope, of superimposed light obtained by superimposing the light from the plurality of optical devices; and
in a case in which the plurality of optical devices is not determined to include a defective product, moving another plurality of optical devices to the inspection position by a moving unit.

2. The inspection method according to claim 1, wherein in a case in which the plurality of optical devices is determined to include a defective product, light is outputted from each individual optical device among the plurality of optical devices, and it is determined whether each individual optical device is a defective product based on a spectrum of the light measured by the spectroscope.

3. The inspection method according to claim 1, wherein the determining of whether the plurality of optical devices includes a defective product is based on a comparison between a side mode suppression ratio of the spectrum of the superimposed light and a predetermined threshold.

4. The inspection method according to claim 1, wherein the spectrum of the superimposed light is measured by inputting the superimposed light to the spectroscope using a beam combiner that combines a plurality of optical fibers that transmit the light outputted from the plurality of optical devices.

5. The inspection method according to claim 4, wherein the superimposed light is inputted to the spectroscope by a bundle optical fiber that bundles the plurality of optical fibers as the beam combiner.

6. An inspection system comprising:
a moving unit that moves an optical device, and a spectroscope that acquires a spectrum of incident light, wherein
the inspection system repeats a process of
outputting light from a plurality of optical devices positioned at an inspection position and determining whether the plurality of optical devices includes a defective product based on a spectrum, measured by the spectroscope, of superimposed light obtained by superimposing the light from the plurality of optical devices; and
in a case in which the plurality of optical devices is not determined to include a defective product, moving another plurality of optical devices to the inspection position by the moving unit.

7. The inspection system according to claim 6, wherein in a case in which the plurality of optical devices is determined to include a defective product, light is outputted from each individual optical device among the plurality of optical devices, and it is determined whether each individual optical device is a defective product based on a spectrum of the light measured by the spectroscope.

8. The inspection system according to claim 6, wherein the determining of whether the plurality of optical devices includes a defective product is based on a comparison between a side mode suppression ratio of the spectrum of the superimposed light and a predetermined threshold.

9. The inspection system according to claim 6, further comprising a beam combiner that combines a plurality of optical fibers that transmit the light outputted from the plurality of optical devices, wherein
the spectroscope measures the spectrum of the superimposed light inputted from the beam combiner.

10. The inspection system of claim 9, comprising, as the beam combiner, a bundle optical fiber that bundles the plurality of optical fibers.

11. The inspection system according to claim 10, wherein
the spectroscope is a monochromator including a diffraction grating, rotatable about a rotation axis, that diffracts incident light at a predetermined angle according to a wavelength of the incident light, and a photodiode that detects an intensity of the superimposed light diffracted by the diffraction grating, the monochromator measuring the spectrum of the superimposed light based on a rotation angle of the diffraction grating and the intensity of the superimposed light detected by the photodiode, and
the beam combiner bundles the plurality of optical fibers in a line perpendicular to a rotation plane of the diffraction grating.

12. A program for controlling operation of an inspection system including a moving unit that moves an optical device, and a spectroscope that acquires a spectrum of incident light, the program configured to cause the inspection system to repeat a process comprising:
outputting light from a plurality of optical devices positioned at an inspection position and determining whether the plurality of optical devices includes a defective product based on a spectrum, measured by the spectroscope, of superimposed light obtained by superimposing the light from the plurality of optical devices; and
in a case in which the plurality of optical devices is not determined to include a defective product, moving another plurality of optical devices to the inspection position by the moving unit.
